(19) United States
(12) Patent Application Publication
(10) Pub. No.: US 2026/0211203 A1
(43) Pub. Date: Jul. 23, 2026

(54) OPTICAL APPARATUS, DISPLAY APPARATUS, IMAGE PICKUP APPARATUS, AND MANUFACTURING METHOD OF OPTICAL APPARATUS

(71) Applicant: CANON KABUSHIKI KAISHA, Tokyo (JP)

(72) Inventor: Toru YATABE, Tochigi (JP)

(21) Appl. No.: 19/445,782

(22) Filed: Jan. 12, 2026

(30) Foreign Application Priority Data
Jan. 22, 2025 (JP) 2025-009030

(51) Int. Cl. G02B 7/02; G02B 1/10

(52) U.S. Cl. CPC G02B 7/02; G02B 1/10

(57) ABSTRACT

An optical apparatus includes a lens having a curved surface, an optical film disposed on at least a part of an effective area of the curved surface, and a holder that holds an edge of the lens via the optical film.

### BACKGROUND

### Field of the Technology

The present disclosure relates to one or more embodiments of an optical apparatus, a display apparatus, an image pickup apparatus, and a manufacturing method of the optical apparatus.

### Description of the Related Art

In recent years, display devices such as head-mounted displays (HMDs) have adopted optical systems that utilize polarization to fold the optical path for reducing its size. In such optical systems, an optical element such as a lens is used in which an optical film is provided on its curved surface. Japanese Patent Application Laid-Open No. 2024-4491 discloses that an adhesive or pressure-sensitive adhesive is used to adhere the optical film to the curved surface of the optical element.

### SUMMARY

One or more embodiments of an optical apparatus according to one or more aspects of the disclosure may include a lens having a curved surface, an optical film disposed on at least a part of an effective area of the curved surface, and a holder that holds an edge of the lens via the optical film. A display apparatus and an image pickup apparatus each having the above optical apparatus also constitute another aspect of the disclosure.

One or more embodiments of a method for manufacturing an optical apparatus according to one or more aspects of the disclosure may include placing an optical film on at least a part of an effective area on a curved surface of a lens, and holding an edge of the lens via the optical film using a holder.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are a (cross-)sectional view and a schematic diagram of an optical apparatus and an optical element according to each example.

FIG. 2 is a schematic diagram of the display apparatus according to each example.

FIG. 3 explains an optical path according to each example.

FIGS. 4A and 4B explain an optical apparatus according to Example 1.

FIGS. 5A and 5B explain an optical apparatus according to Example 2.

FIG. 6 is a sectional view of an optical apparatus according to Example 3.

FIG. 7 is a sectional view of an optical apparatus according to Example 4.

FIG. 8 is a sectional view of an optical apparatus according to Example 5.

FIG. 9 is a sectional view of an optical apparatus according to Example 6.

FIG. 10 is a sectional view of an optical apparatus according to Example 7.

FIG. 11 is a sectional view of an optical apparatus according to Example 8.

FIG. 12 is a schematic diagram of an image pickup apparatus having the optical apparatus according to any one of the above examples.

### DESCRIPTION OF THE EMBODIMENTS

Referring now to the accompanying drawings, a detailed description will be given of examples according to the disclosure. Corresponding elements in respective figures will be designated by the same reference numerals, and a duplicate description thereof will be omitted.

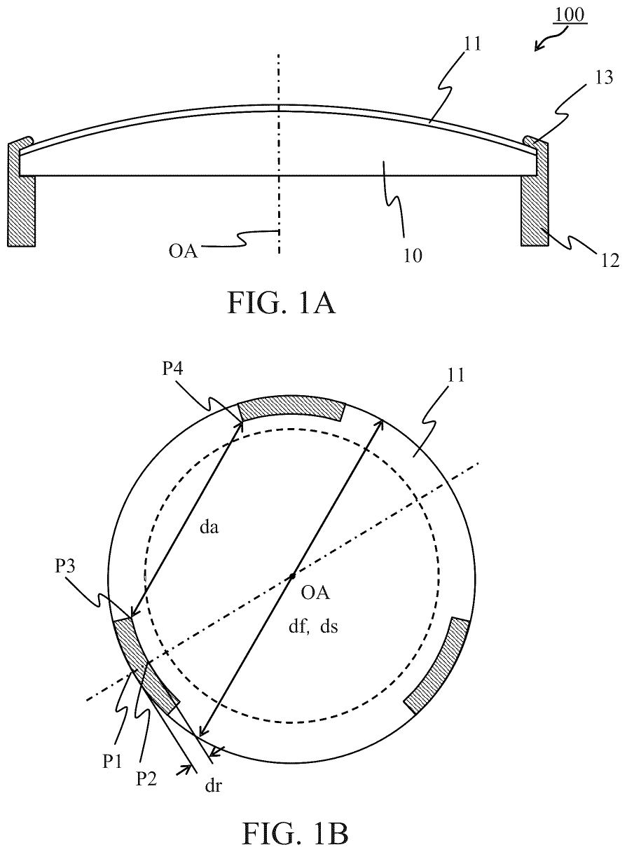

Referring now to FIGS. 1A and 1B, an optical apparatus 100 according to each example will be described. FIG. 1A is a sectional view of the optical apparatus 100. FIG. 1B is a schematic diagram of the optical element (lens) 10 of the optical apparatus 100. The optical apparatus 100 includes an optical element 10, an optical film (optical functional film) 11, a barrel 12, and a support member 13. The optical element 10 is made of a resin material such as COC, COP, acrylic, polycarbonate, or polyester, or glass.

The surface of the optical element 10 to which the optical film 11 is attached is a curved surface. The absolute value of the maximum half-opening angle θ may be in the range of greater than 0 degrees and less than 60 degrees. Here, the half-opening angle is an angle between the surface normal at an arbitrary point on the optical element 10 and the optical axis OA. In a case where the surface of the optical element 10 is spherical, the maximum half-opening angle is an angle between the surface normal at the edge of the maximum effective diameter of the optical element 10 (the maximum value of the diameter through which effective light rays contributing to imaging pass on the surface of the optical element 10) and the optical axis. In a case where the surface of the optical element 10 is aspherical, the surface normal varies according to the position.

In each example, at least one surface of the optical element 10 is a curved surface in an arbitrary cross-section including the optical axis. On the other hand, in a case where it includes a shape that is not a curved surface, since the optical film 11 is attached without stretching, peeling, or lifting of the outer edge of the optical film 11 can be suppressed, but a design is limited and the optical performance deteriorates.

The optical film 11 is disposed on at least a part of the effective area (optically effective area) on the curved surface of the optical element 10 (not limited to the entire effective area, but may be only a part of the effective area). Here, the effective area is the area through which effective light rays contributing to imaging pass on the optical surface, and is the range of the effective diameter illustrated by a broken line in FIG. 1B. In each example, the optical film 11 is not limited to a configuration where it is arranged over the entire effective area, but may be disposed over only a part of the effective area.

The optical film 11 has at least one function of a phase difference plate (retardation plate), a polarization beam splitter, a polarizing plate (or polarizer), an antireflection element, and a color selective element. The optical film 11 also contains a resin material and is different from an optical thin film. In an optically thin film, peeling or lifting from the outer edge does not occur, but the optical functions that can be film-formed are limited. It is more advantageous to use the optical film 11 to obtain optical functions at a low cost. Although not illustrated, the optical film 11 is disposed (adhered) to the optical element 10 via an adhesive or pressure-sensitive adhesive. The adhesive is, for example, an optically transparent material made of a resin material such as acrylic, epoxy, or urethane. The pressure-sensitive adhesive is an optically transparent, pressure-sensitive adhesive made of a resin material such as acrylic, silicone, rubber, or urethane. In this disclosure, “pressure-sensitive adhesive” refers to the property of a material that exhibits adhesiveness by applying a slight pressure for a short time at room temperature. The optical film 11 has a thickness of about 10 to 500 μm and can be configured by laminating a plurality of layers, for example, but is not limited to this structure.

The support member 13 fixes the optical element 10 and the optical film 11 to the barrel 12 by supporting at least a part of the outer edge of the optical element 10 and the optical film 11. The barrel 12 and the support member 13 constitute a holder that holds the optical element 10. The support member 13 supports (holds or fixes) the optical element 10 and the optical film 11 by, for example, caulking, a pressure ring, a barrel, a contact surface of the barrel, an adhesive, a snap fit, or contact with the outer edge of an adjacent optical element. That is, the holder has a pressure ring, a caulking structure, an adhesive, or a snap-fit structure. Alternatively, the holder is a contact portion of another optical element (another lens) adjacent to the optical element 10. Alternatively, the optical film 11 is held by the holder at the reference surface of the optical element 10.

The following inequalities may be satisfied by the optical apparatus 100 according to each example.

The following inequality (1) may be satisfied:

$$0.7 \leq ds / df \leq 1.2 \qquad ( 1 )$$

where df is a maximum diameter of the optical film 11, and ds is a maximum diameter of the optical element 10.

Satisfying inequality (1) can achieve both miniaturization of the optical apparatus 100 and suppression of deterioration of optical performance. In a case where ds/df becomes higher than the upper limit of inequality (1), the optical film 11 is supported near the center of the optical element 10, so if an attempt is made to secure the necessary effective area, the size of the optical apparatus 100 increases. On the other hand, in a case where ds/df becomes lower than the lower limit of inequality (1), the amount by which the optical film 11 protrudes from the optical element 10 increases, and the excess optical film 11 affects the arrangement of the optical element 10, and the optical performance deteriorates.

Each of the maximum diameter ds of the optical element 10 and the maximum diameter df of the optical film 11 refers to the maximum diameter of the optical element 10 or the optical film 11 itself, not the maximum effective diameter. For example, even if a part of the optical element 10 or the optical film 11 is missing, the maximum diameters ds and df are the maximum diameters in the area that is not missing.

Inequality (1) may be replaced with inequality (1a) below:

$$0.75 \leq ds / df \leq 1.15 \qquad ( 1 a )$$

Inequality (1) may be replaced with inequality (1b) below:

$$0.8 \leq ds / df \leq 1.10 \qquad ( 1 b )$$

The following inequality (2) may be satisfied:

$$0.0025 \leq dr / df \leq 0.2000 \qquad ( 2 )$$

where dr is a radial distance from an arbitrary outer edge point P1 of the optical film 11 to a point P2 closest to the center (optical axis OA) of the optical element 10 within the region where the optical film 11 is supported by the holder.

Inequality (2) relates to the support position of the optical film 11. Satisfying inequality (2) can achieve both miniaturization of the optical apparatus 100 and suppression of deterioration of optical performance. In a case where dr/df becomes higher than the upper limit of inequality (2), the optical film 11 will be supported near the center of the optical element 10, and in an attempt to secure the necessary effective area, the size of the optical apparatus 100 increases. On the other hand, in a case where dr/df becomes lower than the lower limit of inequality (2), the region supporting the optical film 11 cannot be sufficiently secured, peeling or lifting of the optical film 11 cannot be suppressed, and the optical performance deteriorates.

Inequality (2) may be replaced with inequality (2a):

$$0.005 \leq dr / df \leq 0.1500 \qquad ( 2 a )$$

Inequality (2) may be replaced with inequality (2b):

$$0.01 \leq dr / df \leq 0.1000 \qquad ( 2 b )$$

In each example, the holder supports the entire circumference of the optical film 11, or supports the optical film 11 in a plurality of regions (support regions, divided regions) that divide the entire circumference of the optical film 11. In the latter case, the following inequality (3) may be satisfied:

$$0. < da / df \leq 0.90 \qquad ( 3 )$$

where da is the shortest distance (distance between point P3 and point P4) between adjacent regions among the plurality of regions supported by the holder.

Inequality (3) relates to the support position of the optical film 11. Satisfying inequality (3) can suppress the deterioration of the optical performance of the optical apparatus 100. In a case where da/df becomes higher than the upper limit of inequality (3), the unsupported region of the optical film 11 increases, and there is a possibility that peeling or lifting of the optical film 11 may occur within the effective area. A smaller support region for the optical film 11 may cause distortion of the optical element 10, prevent the optical element 10 from being properly held in position, and cause the optical performance to deteriorate. Since the support member becomes integral at the lower limit of 0 in inequality (3), da/df does not become lower than the lower limit of inequality (3).

Inequality (3) may be replaced with inequality (3a):

$$0. < da / df \leq 0.85 \qquad ( 3 a )$$

Inequality (3) may be replaced with inequality (3b):

$$0. < da / df \leq 0.80 \qquad ( 3 b )$$

The following inequality (4) may be satisfied:

$$\vert θ \vert \leq 60 \qquad ( 4 )$$

where θ (degrees) is a maximum half-opening angle of the region supporting the optical film 11.

Inequality (4) relates to the shape of the support position of the optical film 11. Here, the maximum half-opening angle refers to the maximum value of the angle between the surface normal at an arbitrary point in the region supporting the optical film 11 and the optical axis of the optical element 10. Satisfying inequality (4) properly fix the optical element 10 to the barrel 12. In a case where |θ| becomes higher than the upper limit of inequality (4), the tilt of the support position of the optical film 11 increases, and the optical element cannot be properly fixed.

Inequality (4) may be replaced with inequality (4a):

$$\vert θ \vert \leq 45 \qquad ( 4 a )$$

Inequality (4) may be replaced with inequality (4b):

$$\vert θ \vert \leq 30 \qquad ( 4 b )$$

In each example, the optical apparatus 100 is manufactured by a first step of disposing the optical film 11 on the curved surface of the optical element 10, and a second step of holding the optical element 10 and the optical film 11 with the barrel 12.

Next, specific application examples of the optical apparatus 100 according to each example will be described. Specific application examples include eyepiece optical systems used in display apparatuses such as head-mounted displays, and imaging optical systems for cameras and video cameras. These optical systems consist of a plurality of optical elements, and each example can be applied to at least one of the plurality of optical elements.

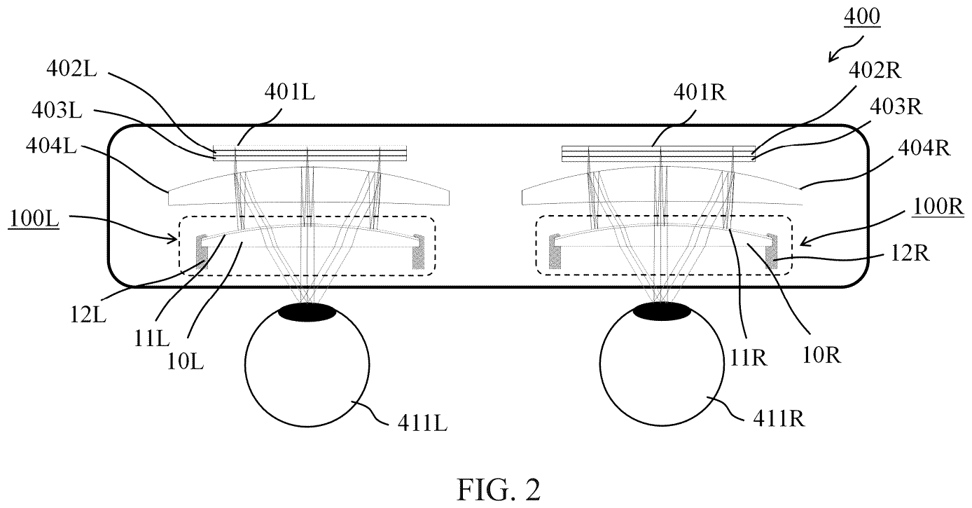

Referring to FIG. 2, a display apparatus using the optical apparatus 100 according to each example will be described. FIG. 2 is a schematic diagram of a head mounted display (HMD) 400, which is an example of a display apparatus using the optical apparatus 100 according to each example.

The HMD 400 has a right-eye eyepiece optical system and a left-eye eyepiece optical system corresponding to the user's right eye 411R and the user's left eye 411L. The right-eye eyepiece optical system is configured by an optical element 404R and an optical apparatus 100R. The left-eye eyepiece optical system is configured by an optical element 404L and an optical apparatus 100L. A display element (right-eye display element) 401R and the display element (left-eye display element) 401L are organic EL displays. Between the display elements 401R and 401L and the optical elements 404R and 404L, polarizing plates 402R and 402L, and phase plates 403R and 403L are respectively disposed, converting the unpolarized light emitted from the display elements 401R and 401L into circularly polarized light.

The right-eye eyepiece optical system magnifies and projects the original image displayed on the display element 401R as a virtual image and guides it to the user's right eye 411R. The left-eye eyepiece optical system magnifies and projects the original image displayed on the left-eye display element 401L as a virtual image and guides it to the user's left eye 411L. Each eyepiece optical system is an optical system that folds the optical path using polarization, and a half-mirror is deposited on the first surface of the optical elements 404R and 404L.

Optical films 11R and 11L are in close contact with the display element side surfaces of the optical elements (lenses) 10R and 10L. Each of the optical films 11R and 11L is configured by laminating an antireflection film, a phase plate, and a polarization splitting film in that order from the side closer to the display elements 401R and 401L. In the optical apparatuses 100R and 100L, barrels 12R and 12L support and fix at least a part of the outer circumference of the optical elements 10R and 10L and the optical films 11R and 11L.

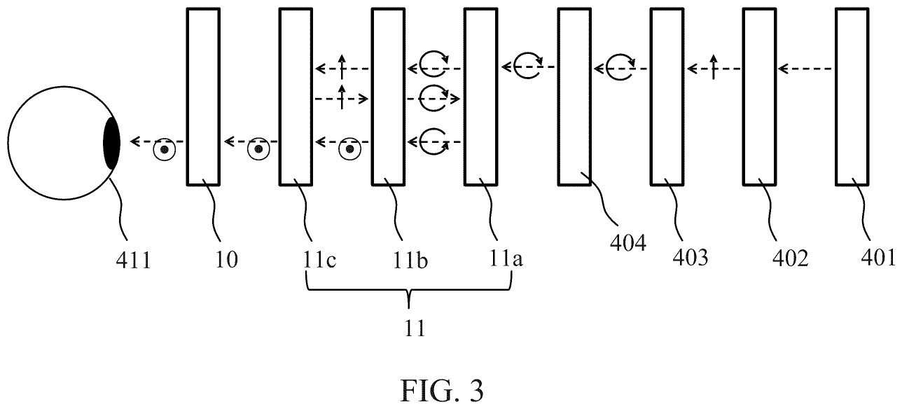

Next, an optical path according to each example will be described with reference to FIG. 3. FIG. 3 explains the optical path according to each example.

The light emitted from the display element 401 passes through the polarizing plate 402 to become linearly polarized light, and then passes through the phase plate 403 to become circularly polarized light. It passes through the half-mirror on the first surface of the optical element 404 and the antireflection film 11a, suppressing reflected light that causes ghosts, and then passes through the phase plate 11b to become linearly polarized light. The polarization direction of the linearly polarized light is orthogonal to the polarization direction transmitted by the polarizing splitting film 11c. Therefore, it is reflected by the polarizing splitting film 11c, passes through the phase plate 11b, and becomes circularly polarized light. After passing through the antireflection film 11a, it is reflected by the half-mirror, and after passing through the antireflection film 11a again, it passes through the phase plate 11b and becomes linearly polarized light. The polarization direction of this linearly polarized light, unlike the above, coincides with the polarization direction transmitted by the polarizing splitting film 11c, so it passes through the polarizing splitting film 11c, passes through the optical element 10, and is finally guided to the user's eye 411.

Supporting the outer edge of the optical element 10 and the optical film 11 and fixing them to the barrel 12 can prevent peeling and lifting of the outer edges of the optical film 11 and suppress the deterioration of optical performance.

In each example, a value obtained by subtracting twice as large as the distance dr from the maximum diameter df of the optical film 11 or the maximum diameter ds of the optical element 10 may be equal to or greater than the effective diameter (effective area) illustrated by the broken line in FIG. 1B.

The following is a detailed description of each example.

### Example 1

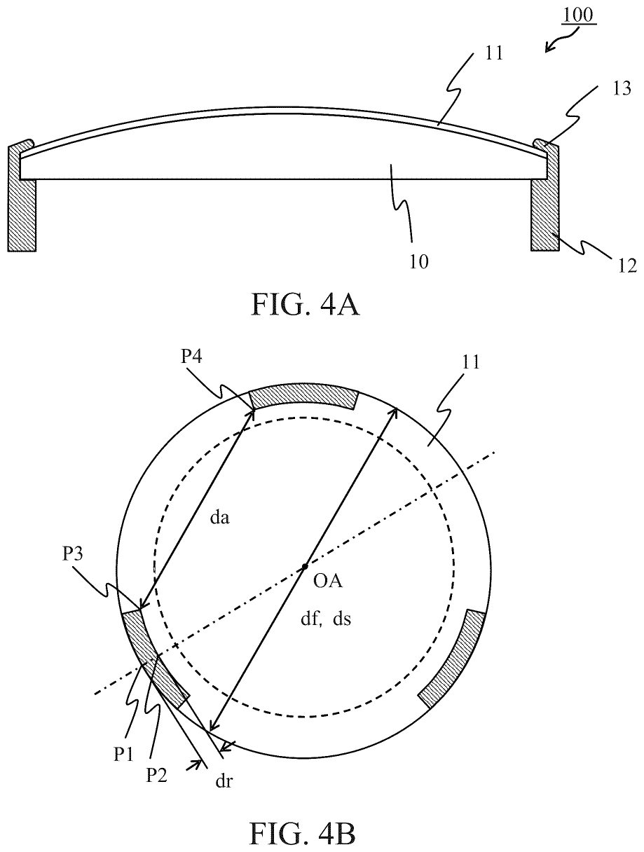

Referring now to FIGS. 4A and 4B, a description will be given of the optical apparatus 100 according to Example 1. FIGS. 4A and 4B are a sectional view of the optical apparatus 100 and a schematic diagram of the optical element 10 according to this example. As illustrated in FIG. 4A, the optical element 10 and the optical film 11, which is adhered to the optical element 10 via an adhesive, are inserted into the inner diameter portion of the barrel 12 from the optical axis direction, and the optical element 10 contacts the contact portion of the barrel 12. A part of the barrel 12 is thermally caulked to form a support member 13, and the optical element 10 and the optical film 11 are fixed to the barrel 12. In this case, the optical film 11 is a film in which a polarization splitting film, a phase difference plate, and an antireflection film are laminated. The maximum diameter ds of the optical element 10 is 40 mm, and the maximum diameter df of the optical film 11 is 40 mm.

As illustrated in FIG. 4B, the distance dr from an arbitrary outer edge of the optical film 11 to the point closest to the center of the region supporting the optical film 11 by thermal caulking is 3 mm. The region supported by thermal caulking is divided into three regions, and the distance da between adjacent supported regions is 30.8 mm. That is, in this example, the support member 13 supports the optical film 11 in a plurality of regions (support regions, divided regions) that divide the entire circumference of the optical film 11.

The support region and the effective portion are represented by the same shape equation and have a continuous shape. The maximum half-opening angle of the support region is 20 degrees. In this example, the support region and the effective portion are represented by the same shape equation, but it is sufficient if the support region and the effective portion are represented by separate equations as long as they have a continuous shape.

Table 1 summarizes the various characteristics of this example.

TABLE 1

| ITEM | EXAMPLE 1 |
|---|---|
| SURFACE SHAPE | SPHERICAL |
| OPTICAL FUNCTION | POLARIZING SPLITTING FILM, |
| FILM TYPE | PHASE DIFFERENCE PLATE, |
| | ANTIREFLECTION FILM |
| CLOSE CONTACT METHOD | PRESSURE-SENSITIVE |
| | ADHESIVE |
| SUPPORT METHOD | THERMAL CAULKING |
| CONTINUITY BETWEEN | ◯ |
| SUPPORT REGION AND | |
| EFFECTIVE PORTION | |
| INEQUALITY (1)ds/df | 0.8 |
| INEQUALITY (2)dr/df | 0.075 |
| INEQUALITY (3)da/df | 0.77 |
| INEQUALITY (4) \| θ \| | 20 |

The optical apparatus 100 can be determined as good because no peeling or lifting is observed to penetrate into the effective area, and therefore it does not affect the optical performance.

### Example 2

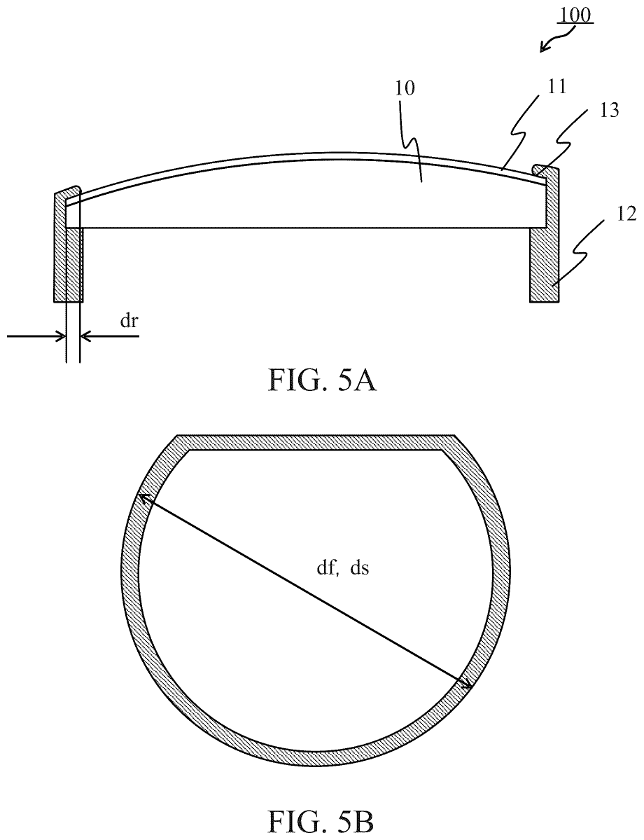

Next, an optical apparatus 100 according to Example 2 will be described with reference to FIGS. 5A and 5B. FIGS. 5A and 5B are a sectional view of the optical apparatus 100 and a schematic diagram of the optical element 10 according to this example. As illustrated in FIG. 5A, the optical element 10 and the optical film 11, which is adhered to the optical element 10 via an adhesive, are inserted into the inner diameter portion of the barrel 12 from the optical axis direction, and the optical element 10 contacts the contact portion of the barrel 12. A part of the barrel 12 is thermally caulked to form a support member 13, and the optical element 10 and the optical film 11 are fixed to the barrel 12. The optical film 11 is a polarizing splitting film, and the maximum diameter ds of the optical element is 40 mm, and the maximum diameter df of the optical film is 40 mm.

As illustrated in FIG. 5B, the optical element 10 has an outer shape in which a part of a circle is flat. The distance dr from an arbitrary outer edge of the optical film 11 to the point closest to the center of the region where the optical film 11 is supported by thermal caulking is 3 mm, and the entire circumference of the optical film 11 is supported by thermal caulking. In this example, the outer shape of the optical element 10 is such that one part of the circle is flat, but it may have an outer shape such as a shape in which a plurality of positions of the circle are flat or elliptical.

The support region and the effective area are represented by the same shape equation and have a continuous shape. The maximum half-angle of the support region is 20 degrees.

Table 2 summarizes the various characteristics of this example.

TABLE 2

| ITEM | EXAMPLE 2 |
|---|---|
| SURFACE SHAPE | SPHERICAL |
| OPTICAL FUNCTION FILM TYPE | POLARIZING SPLITTING FILM |
| CLOSE CONTACT METHOD | ADHESIVE |
| SUPPORT METHOD | THERMAL CAULKING |
| CONTINUITY BETWEEN | ◯ |
| SUPPORT REGION AND | |
| EFFECTIVE PORTION | |
| INEQUALITY (1)ds/df | 1 |
| INEQUALITY (2)dr/df | 0.025 |
| INEQUALITY (3)da/df | ENTIRE CIRCUMFERENCE |
| | SUPPORT |
| INEQUALITY (4) \| θ \| | 20 |

The optical apparatus 100 is determined as good because no peeling or lifting is observed to penetrate into the effective area, and therefore it does not affect the optical performance.

### Example 3

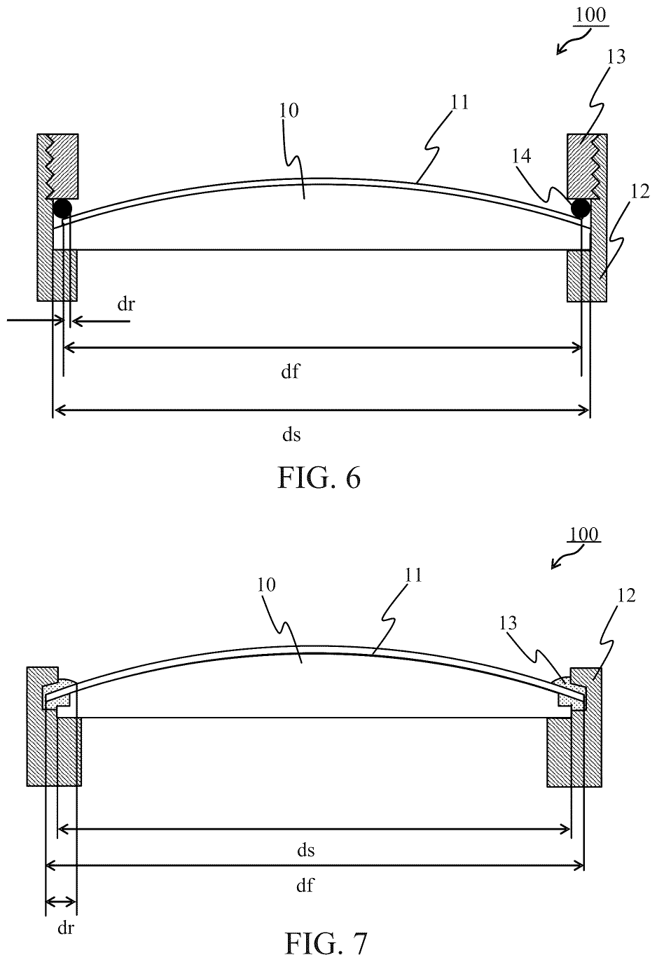

Referring now to FIG. 6, an optical apparatus 100 according to Example 3 will be described. FIG. 6 is a sectional view of the optical apparatus 100 according to this example. As illustrated in FIG. 6, the optical element 10 and the optical film 11, which is adhered to the optical element 10 via an adhesive, are inserted into the inner diameter portion of the barrel 12 from the optical axis direction, and the optical element 10 contacts the contact portion of the barrel 12. The optical element 10 and the optical film 11 are fixed to the barrel 12 via a buffer member 14. That is, in this example, the holder includes the barrel 12 and the buffer member 14 disposed between the optical film 11 and the barrel 12.

In this example, the support member 13 includes a pressure ring and supports the optical film 11 via the buffer member 14 to alleviate pressure on the optical film 11. The optical film 11 is a polarizing splitting film, the maximum diameter ds of the optical element 10 is 40 mm, and the maximum diameter df of the optical film 11 is 38.5 mm. The distance dr from an arbitrary outer edge of the optical film 11 to the point closest to the center of the region supporting the optical film 11 is 1 mm, and the entire circumference of the optical film 11 is supported.

The support region and the effective portion are represented by the same shape equation and have a continuous shape. The maximum half-opening angle of the support region is 19 degrees.

Table 3 summarizes the various characteristics of this example.

TABLE 3

| ITEM | EXAMPLE 3 |
|---|---|
| SURFACE SHAPE | SPHERICAL |
| OPTICAL FUNCTION | POLARIZING SPLITTING FILM |
| FILM TYPE | |
| CLOSE CONTACT METHOD | PRESSURE-SENSITIVE ADHESIVE |
| SUPPORT METHOD | PRESSURE RING |
| CONTINUITY BETWEEN | ◯ |
| SUPPORT REGION AND | |
| EFFECTIVE PORTION | |
| INEQUALITY (1)ds/df | 1.04 |
| INEQUALITY (2)dr/df | 0.026 |
| INEQUALITY (3)da/df | ENTIRE CIRCUMFERENCE |
| | SUPPORT |
| INEQUALITY (4) \| θ \| | 19 |

The optical apparatus 100 is determined to be good because no peeling or lifting is observed to penetrate into the effective area, and therefore it does not affect the optical performance.

### Example 4

Referring now to FIG. 7, an optical apparatus 100 according to Example 4 will be described. FIG. 7 is a sectional view of the optical apparatus 100 according to this example. As illustrated in FIG. 7, the optical element 10 and the optical film 11, which is adhered to the optical element 10 via an adhesive, are inserted into the inner diameter portion of the barrel 12 from the optical axis direction, and the optical element 10 contacts the contact portion of the barrel 12. The optical element 10 and the optical film 11 are supported by a support member 13 and fixed to the barrel 12.

In this example, the support member 13 is an ultraviolet curable resin, and fixation is possible even if the end shape is complex. Even if there is an unadhered area between the optical element 10 and the outer edge of the optical film 11, since it is covered with ultraviolet curable resin, it is possible to prevent peeling, lifting, and shedding of chips from the edge of the optical film 11.

The optical film 11 is a polarizing splitting film. The maximum diameter ds of the optical element 10 is 40 mm, and the maximum diameter df of the optical film 11 is 42.1 mm. The distance dr from an arbitrary outer edge of the optical film 11 to the point closest to the center of the area supporting the optical film 11 is 1.5 mm, and the entire circumference of the optical film 11 is supported.

The support region and the effective area are represented by the same shape equation and have a continuous shape. The maximum half-angle of the support region is 18.5 degrees.

Table 4 summarizes the various characteristics of this example.

TABLE 4

| ITEM | EXAMPLE 4 |
|---|---|
| SURFACE SHAPE | SPHERICAL |
| OPTICAL FUNCTION | POLARIZING SPLITTING FILM |
| FILM TYPE | |
| CLOSE CONTACT METHOD | PRESSURE-SENSITIVE ADHESIVE |
| SUPPORT METHOD | UV CURABLE RESIN |
| CONTINUITY BETWEEN | ◯ |
| SUPPORT REGION AND | |
| EFFECTIVE PORTION | |
| INEQUALITY (1)ds/df | 0.95 |
| INEQUALITY (2)dr/df | 0.036 |
| INEQUALITY (3)da/df | ENTIRE CIRCUMFERENCE |
| | SUPPORT |
| INEQUALITY (4) \| θ \| | 18.5 |

The optical apparatus 100 is determined to be good because no peeling or lifting was observed to penetrate into the effective area, and therefore it does not affect the optical performance.

### Example 5

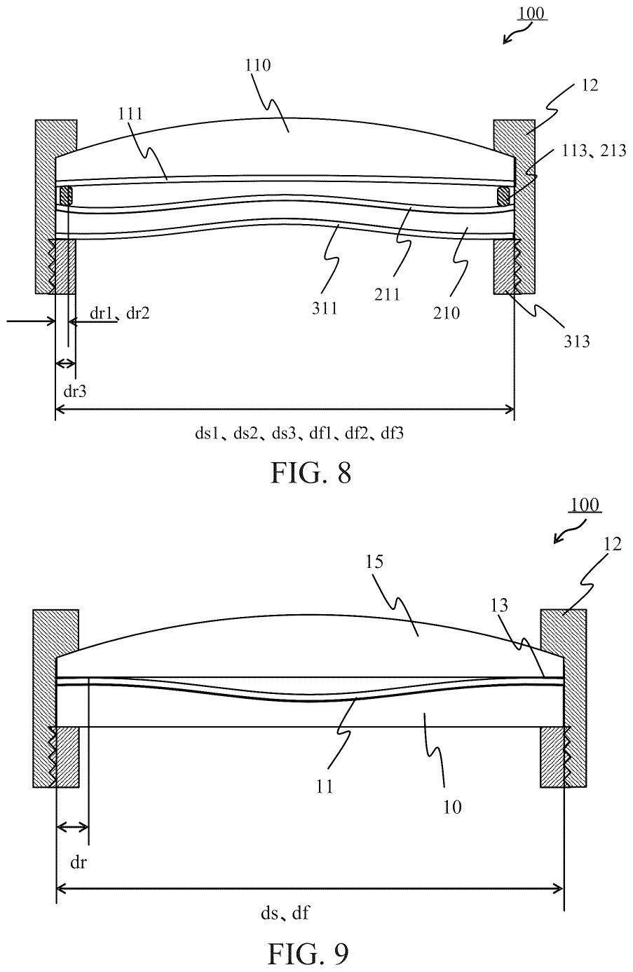

Next, with reference to FIG. 8, the optical apparatus 100 according to Example 5 will be described. FIG. 8 is a sectional view of the optical apparatus 100 according to this example. As illustrated in FIG. 8, the optical element (lens) 110 and the optical film 111, which is adhered to the optical element 110 via an adhesive, are inserted into the inner diameter portion of the barrel 12 from the optical axis direction, and the optical element 110 contacts the contact portion of the barrel 12. Next, the optical element (lens) 210, to which the support members 113 and 213 and the optical films 211 and 311 are attached, is inserted and fixed to the barrel 12 by the support member 313. In this example, the support members 113 and 213 are barrels that also serve as a pressure ring, and the support member 313 is a pressure ring, capable of simultaneously supporting the optical films 111, 211, and 311.

The optical film 111 is a laminated film of a phase plate and an antireflection film. The optical film 211 is a polarizing splitting film. The optical film 311 is a laminated film of a polarizing film and an antireflection film. The maximum diameters ds1 and ds2 of the optical elements 110 and 210 are both 40 mm. The maximum diameters df of the optical films 111, 211, and 311 are all 40 mm. The distances dr1, dr2, and dr3 from an arbitrary outer edge of the optical films 111, 211, and 311 to the point closest to the center of the region supporting the optical films 111, 211, and 311 are 2 mm, 2 mm, and 3 mm, respectively, and the entire circumference of the optical films is supported.

The support regions and effective areas of the optical elements 110 and 210 are represented by the same shape equation and have a continuous shape. The maximum half-opening angles θ1, θ2, and θ3 of the support regions are 2.7 degrees, 7.3 degrees, and 1.5 degrees, respectively.

Table 5 summarizes the various characteristics of this example.

TABLE 5

| | EXAMPLE 5 | | |
|---|---|---|---|
| ITEM | 111 | 211 | 313 |
| SURFACE SHAPE | SPHERICAL | ASPHERIC | ASPHERIC |
| OPTICAL FUNCTION | PHASE DIFFERENCE PLATE, | POLARIZING SPLITTING | POLARIZING FILM, |
| FILM TYPE | ANTIREFLECTION FILM | FILM | ANTIREFLECTION FILM |
| CLOSE CONTACT | PRESSURE-SENSITIVE | PRESSURE-SENSITIVE | PRESSURE-SENSITIVE |
| METHOD | ADHESIVE | ADHESIVE | ADHESIVE |
| SUPPORT METHOD | BARREL(113) | BARREL(213) | PRESSURE RING (313) |
| CONTINUITY | ◯ | ◯ | ◯ |
| BETWEEN SUPPORT | | | |
| REGION AND EFFECTIVE | | | |
| PORTION | | | |
| INEQUALITY ( 1)ds/df | 1 | 1 | 1 |
| INEQUALITY (2)dr/df | 0.05 | 0.05 | 0.075 |
| INEQUALITY (3)da/df | ENTIRE CIRCUMFERENCE | ENTIRE CIRCUMFERENCE | ENTIRE CIRCUMFERENCE |
| | SUPPORT | SUPPORT | SUPPORT |
| INEQUALITY (4) \| θ \| | 2.7 | 7.3 | 1.5 |

The optical apparatus 100 is determined to be good because no peeling or lifting was observed to penetrate into the effective area, and therefore it does not affect the optical performance.

### Example 6

Referring now to FIG. 9, an optical apparatus 100 according to Example 6 will be described. FIG. 9 is a sectional view of the optical apparatus 100 according to this example. As illustrated in FIG. 9, the optical element (lens) 15, and the optical element 10 and the optical film 11 adhered to the optical element 10 via an adhesive, are inserted into the inner diameter portion of the barrel 12 from the optical axis direction, and the optical element 15 contacts the contact portion of the barrel 12. The optical element 10 and the optical film 11 use a part of the optical element 15 as a support member 13 to support the outer edge of the optical film 11, and are fixed to the barrel 12 using a pressure ring from the surface opposite to the surface where the optical film 11 is in close contact with the optical element 10. In this example, by using a part of the optical element 15 as the support member 13, the number of parts can be reduced.

The optical film 11 is a polarizing splitting film. The maximum diameter ds of the optical element 10 is 40 mm, and the maximum diameter df of the optical film 11 is 40 mm. The distance dr from an arbitrary outer edge of the optical film 11 to the point closest to the center of the region supporting the optical film 11 is 1.5 mm, and the entire circumference of the optical film 11 is supported.

The support region and the effective portion are represented by the same shape equation and have a continuous shape. The maximum half-opening angle of the support region is 0 degrees.

Table 6 summarizes the various characteristics of this example.

TABLE 6

| ITEM | EXAMPLE 6 |
|---|---|
| SURFACE SHAPE | ASPHERIC |
| OPTICAL FUNCTION | POLARIZING SPLITTING FILM |
| FILM TYPE | |
| CLOSE CONTACT METHOD | PRESSURE-SENSITIVE ADHESIVE |
| SUPPORT METHOD | LENS CONTACT |
| CONTINUITY BETWEEN | ◯ |
| SUPPORT REGION AND | |
| EFFECTIVE PORTION | |
| INEQUALITY (1)ds/df | 1 |
| INEQUALITY (2)dr/df | 0.038 |
| INEQUALITY (3)da/df | ENTIRE CIRCUMFERENCE |
| | SUPPORT |
| INEQUALITY (4) \| θ \| | 0 |

The optical apparatus 100 is determined to be good because no peeling or lifting into the effective area is observed, and therefore it does not affect the optical performance.

### Example 7

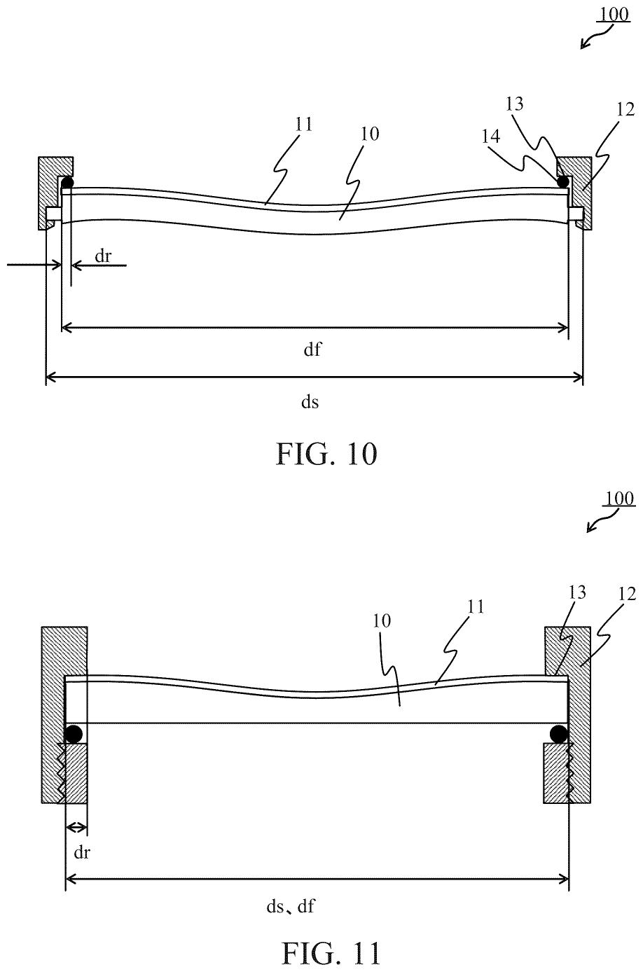

Next, an optical apparatus 100 according to Example 7 will be described with reference to FIG. 10. FIG. 10 is a sectional view of the optical apparatus 100 according to this example.

As illustrated in FIG. 10, the optical element 10 and the optical film 11, which is adhered to the optical element 10 via an adhesive, are inserted into the inner diameter portion of the barrel 12 from the optical axis direction, and the outer shape of the optical element 10 contacts the contact portion of the barrel 12. This allows the optical element 10 and the optical film 11 to be fixed to the barrel 12 by a support member 13, which is part of the barrel 12.

In this example, the support member 13 is a member integrally molded with the barrel 12 and a snap fit, and is supported by the barrel 12 via a buffer member 14. In this example, since the outer shape on the optical film side of the optical element 10 is used as a reference surface for positioning, it is not affected by tolerances such as the thickness of the optical element 10. Therefore, the positioning accuracy of the optical film 11 is improved, and the deterioration of optical performance is suppressed.

The optical film 11 is a polarizing splitting film, the maximum diameter ds of the optical element 10 is 40.25 mm, and the maximum diameter df of the optical film 11 is 40 mm. The distance dr from an arbitrary outer edge of the optical film 11 to the point closest to the center of the region supporting the optical film 11 is 0.5 mm, and the entire circumference of the optical film 11 is supported.

The support region and the effective area are represented by the same shape equation and have a continuous shape. The maximum half-opening angle of the support region is 1.5 degrees.

Table 7 summarizes the various characteristics of this example.

TABLE 7

| ITEM | EXAMPLE 7 |
|---|---|
| SURFACE SHAPE | ASPHERIC |
| OPTICAL FUNCTION FILM TYPE | POLARIZING SPLITTING FILM |
| CLOSE CONTACT METHOD | ADHESIVE |
| SUPPORT METHOD | BARREL + SNAP-FIT |
| CONTINUITY BETWEEN | ◯ |
| SUPPORT REGION AND | |
| EFFECTIVE PORTION | |
| INEQUALITY (1)ds/df | 1.006 |
| INEQUALITY (2)dr/df | 0.013 |
| INEQUALITY (3)da/df | ENTIRE CIRCUMFERENCE |
| | SUPPORT |
| INEQUALITY (4) \| θ \| | 1.5 |

The optical apparatus 100 is determined to be good because no peeling or lifting is observed to penetrate into the effective area, and therefore it does not affect the optical performance.

### Example 8

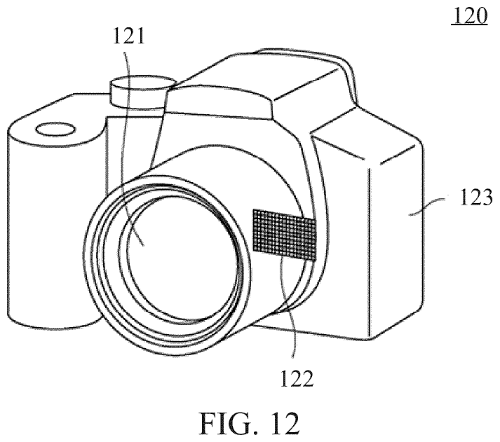

Next, with reference to FIG. 11, an optical apparatus 100 according to Example 8 will be described. FIG. 11 is a sectional view of the optical apparatus 100 according to this example.

As illustrated in FIG. 11, the optical element 10 and the optical film 11, which is adhered to the optical element 10 via an adhesive, are inserted into the inner diameter portion of the barrel 12 from the optical axis direction, and the optical film 11 contacts the contact portion of the barrel 12. The contact portion is used as the support member 13, and the optical element 10 is fixed to the barrel 12 with a pressure ring from the surface opposite to the surface where the optical film 11 is in close contact.

In this example, by using a surface that the optical film 11 contacts as a reference surface, the optical film 11 can be positioned without being affected by variations in the thickness of the optical film 11. In particular, in a case where the optical film 11 is a polarizing splitting film, the sensitivity of the disposition is high. Therefore, positioning the optical film 11 in a way that is not affected by variations in its thickness can suppress the degradation of optical performance.

The optical film 11 is a polarizing splitting film. The maximum diameter ds of the optical element 10 is 40 mm, and the maximum diameter df of the optical film 11 is 40 mm. The distance dr from an arbitrary outer edge of the optical film 11 to the point closest to the center of the region supporting the optical film 11 is 2.5 mm, and the entire circumference of the optical film 11 is supported.

The support region and the effective area are represented by the same shape equation and have a continuous shape. The maximum half-opening angle of the support region is 1.5 degrees.

Table 8 summarizes the various characteristics of this example.

TABLE 8

| ITEM | EXAMPLE 8 |
|---|---|
| SURFACE SHAPE | ASPHERIC |
| OPTICAL FUNCTION | POLARIZING SPLITTING FILM |
| FILM TYPE | |
| CLOSE CONTACT METHOD | PRESSURE-SENSITIVE ADHESIVE |
| SUPPORT METHOD | CONTACT SURFACE |
| CONTINUITY BETWEEN | ◯ |
| SUPPORT REGION AND | |
| EFFECTIVE PORTION | |
| INEQUALITY (1)ds/df | 1 |
| INEQUALITY (2)dr/df | 0.063 |
| INEQUALITY (3 )da/df | ENTIRE CIRCUMFERENCE |
| | SUPPORT |
| INEQUALITY (4) \| θ \| | 1.5 |

The optical apparatus 100 is determined to be good because no peeling or lifting was observed to penetrate into the effective area, and therefore it does not affect the optical performance.

### Image Pickup Apparatus

Referring now to FIG. 12, a description will be given of an image pickup apparatus 120 using the optical apparatus 100 according to each example as an imaging optical system. FIG. 12 is a schematic diagram of the image pickup apparatus 120.

In FIG. 12, reference numeral 123 denotes a camera body, and reference numeral 121 denotes an imaging optical system that includes any one of the optical apparatuses 100 according to Examples 1 to 8. Reference numeral 122 denotes an image sensor (photoelectric conversion element) such as a CCD sensor or a CMOS sensor, which is built into the camera body 123 and receives the optical image formed by the imaging optical system 121 and performs photoelectric conversion. The camera body 123 may be a so-called single-lens reflex camera with a quick-return mirror, or a so-called mirrorless camera without a quick-return mirror. Applying the optical apparatus 100 according to each example to the image pickup apparatus 120 in this way can provide an image pickup apparatus with high optical performance. Furthermore, the optical apparatus 100 according to each example can be similarly applied to a video camera.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each example can provide an optical apparatus that has a reduced size and high optical performance.

This application claims the benefit of Japanese Patent Application No. 2025-009030, filed on Jan. 22, 2025, which is hereby incorporated by reference herein in its entirety.

What is claimed is:

1. An optical apparatus comprising:
a lens having a curved surface;
an optical film disposed on at least a part of an effective area of the curved surface; and
a holder that holds an edge of the lens via the optical film.

2. The optical apparatus according to claim 1, wherein the optical film is in close contact with the curved surface.

3. The optical apparatus according to claim 1, wherein the optical film includes resin.

4. The optical apparatus according to claim 1, wherein the optical film is disposed on the curved surface via an adhesive or a pressure-sensitive adhesive.

5. The optical apparatus according to claim 1, wherein the following inequality is satisfied:
$$0.7 \leq ds / df \leq 1.2$$
where df is a maximum diameter of the optical film, and ds is a maximum diameter of the lens.

6. The optical apparatus according to claim 1, wherein the following inequality is satisfied:
$$0.0025 \leq dr / df \leq 0.2000$$
where dr is a distance from an outer edge point of the optical film to a point closest to a center of the lens in a region where the optical film is supported by the holder.

7. The optical apparatus according to claim 1, wherein the holder supports an entire circumference of the optical film.

8. The optical apparatus according to claim 1, wherein the holder supports the optical film in a plurality of regions obtained by dividing an entire circumference of the optical film.

9. The optical apparatus according to claim 8, wherein the following inequality is satisfied:
$$0. < da / df \leq 0.90$$
where da is a shortest distance between adjacent regions among the plurality of regions supported by the holder, and df is a maximum diameter of the optical film.

10. The optical apparatus according to claim 1, wherein the optical film has at least one function of a phase difference plate, a polarization beam splitter, a polarizing plate, an antireflection element, and a color selective element.

11. The optical apparatus according to claim 1, wherein the holder is a pressure ring.

12. The optical apparatus according to claim 1, wherein the holder has a caulking structure.

13. The optical apparatus according to claim 1, wherein the holder is a contact portion of another lens adjacent to the lens.

14. The optical apparatus according to claim 1, wherein the optical film is held by the holder on a reference surface of the lens.

15. The optical apparatus according to claim 1, wherein the following inequality is satisfied:
$$\vert θ \vert \leq 60$$
where θ (degrees) is a maximum half-opening angle of a region supporting the optical film.

16. The optical apparatus according to claim 1, wherein the holder is a barrel that holds the lens.

17. The optical apparatus according to claim 1, wherein the holder includes:
a barrel that holds the lens, and
a buffer member disposed between the optical film and the barrel.

18. A display apparatus comprising:
the optical apparatus according to claim 1; and
a display element.

19. An image pickup apparatus comprising:
the optical apparatus according to claim 1; and
an image sensor.

20. A method for manufacturing an optical apparatus, the method comprising:
placing an optical film on at least a part of an effective area on a curved surface of a lens; and
holding an edge of the lens via the optical film using a holder.
